(19) United States
(12) Patent Application Publication
(10) Pub. No.: US 2015/0362444 A1
(43) Pub. Date: Dec. 17, 2015

(54) PHASE INFORMATION ACQUISITION APPARATUS AND IMAGING SYSTEM

(71) Applicant: CANON KABUSHIKI KAISHA, Tokyo (JP)

(72) Inventor: Kentaro Nagai, Yokohama-shi (JP)

(21) Appl. No.: 14/731,665

(22) Filed: Jun. 5, 2015

(30) Foreign Application Priority Data
Jun. 12, 2014 (JP) 2014-121396

(51) Int. Cl. G01N 23/20; G06T 7/00

(52) U.S. Cl. CPC G01N 23/20075; G06T 7/0085; G06T 2207/10116; G06T 2207/20192

(57) ABSTRACT

A phase information acquisition apparatus that acquires phase information from differential phase information on an object, includes: a differential phase acquisition unit that acquires differential phase information with respect to a plurality of directions; a weight setting unit that individually sets weights for the differential phase information of the respective directions; and a phase acquisition unit that determines phase information, using an equation that includes a weighted combination of the differential phase information of the respective directions with the weights of the respective directions set by the weight setting unit.

### BACKGROUND OF THE INVENTION

1. Field of the Invention

The present invention relates to a technology for acquiring phase information from differential phase information.

2. Description of the Related Art

Measurement methods using phase have conventionally been used as means for precisely measuring substances. In measurement methods using phase, interference is induced in incident light having a uniform wave front (coherent incident light) followed by measuring interference fringes to measure the change in the incident light wave front (phase) caused by a phase difference of one severalth to a several tenth of the wavelength. This interferometer is preferable means for measuring slight unevenness present in the surface of a lens, for example.

Moreover, among wave front measurement methods that use interference, the field of X-ray phase imaging has attracted considerable attention in recent years. X-ray phase imaging differs from conventional X-ray absorption imaging, in which contrast images are obtained based on absorption of X-rays by an object, in that it is means for detecting changes in the phase of incident light, which occur during transmission of X-rays through an object, according to the interference fringes thereof. As a result of detecting phase changes, objects having a low absorption coefficient such as soft body tissue, for which detection was difficult with conventional absorption images, can be observed.

The following provides a description of X-ray Talbot interferometry as an example of X-ray phase imaging. In X-ray Talbot interferometry, coherent or partially coherent X-rays from a light source pass through an object and the incident phase of the light changes accompanying that transmission. As a result of the light that has passed through the object being diffracted with a grating having a periodic pattern referred to as a diffraction grating, a first interference pattern referred to as a self-image is formed at a position at a prescribed distance away from the diffraction grating referred to as Talbot length. A change in the incident phase attributable to the object as previously described is measured by comparatively analyzing the change in the first interference pattern with the case of the absence of the object.

The period and structure of the pattern of a diffraction grating having a periodic pattern as described above change according to conditions such as apparatus length or wavelength of the incident light. Typically in the case of X-rays, the period of a pattern is on the order of several micrometers. In addition, the first interference pattern formed thereby is also known to have a period on the order of several micrometers. Since detectors typically used in such cases have a resolution of at most several tens of micrometers, it is not possible to detect the first interference pattern with these detectors. Consequently, a shield grating (absorption grating), having the same or nearly the same period as that of the first interference pattern, is arranged at the position where the interference pattern is formed. As a result of shielding a portion of the first interference pattern with the shield grating, a second interference pattern having a period of about several hundred micrometers (to be referred to as a moire pattern) is formed, and changes in the first interference pattern can be measured indirectly by detecting this moire pattern with a detector.

The above-mentioned diffraction grating and shield grating consist of those having a one-dimensional periodic change (such as a striped pattern) and those having a two-dimensional form in the manner of a checkerboard pattern or mesh pattern. A Talbot interferometer is a differential interferometer, and primary information acquired by moire pattern-based phase retrieval is the phase difference between two adjacent points, namely the differential phase. The use of a grating having a two-dimensional form makes it possible to acquire differential phase information with respect to two axes such as the direction of the x-axis and the direction of the y-axis.

Phase retrieval methods are techniques for interpreting differential phase from a moire pattern. Although there are several examples of phase retrieval methods, they are thought to be broadly divided into two types. The first type is a Fourier transform method. In this method, a moire image is subjected to Fourier transform, data around the spectrum that coincides with the carrier frequency thereof is extracted over a fixed range, and differential phase information is acquired by inverse Fourier transform of the data. This method is the same in the case of a two-dimensional grating in that data around the spectrum that coincides with a carrier frequency present in a two-dimensional plane within Fourier space is extracted, followed by retrieving the differential phase by subjecting to inverse Fourier transform.

A second example of a phase retrieval method is the fringe scanning method. The fringe scanning method consists of capturing a plurality of images while changing the positional relationship between the above-mentioned diffraction grating and shield grating. Since the moire pattern changes according to that positional relationship, differential phase can be calculated from the amount of that change.

Primary information acquired from the moire patterns of either of these methods is in the form of a differential phase. Thus, in calculating phase quantitative properties, it is necessary to carry out calculations consisting of integrating differential phase information, and then retrieve the incident light wave front attributable to the original object, namely an image that represents the amount of phase change (also referred to as an integrated phase image in the present application). Since the use of a two-dimensional grating as previously described makes it possible to use two-dimensional differential phase information taken along at least two axes in integration, this is known to allow the obtaining of an integrated phase image having a low noise level.

Fourier integral method is known to be primarily used for this integral method. In addition, an integration technique based on Poisson's integral method has also been proposed as a variation of this method (U.S. Pat. No. 9,019,479). Poisson's integral method is a method whereby a Poisson's equation is formed from differential phase equations in the x direction and y direction, respectively, and phase is determined by solving this equation.

### SUMMARY OF THE INVENTION

The present invention in its first aspect provides a phase information acquisition apparatus that acquires phase information from differential phase information on an object, including: a differential phase acquisition unit that acquires differential phase information with respect to a plurality of directions; a weight setting unit that individually sets weights for the differential phase information of the respective directions; and a phase acquisition unit that determines phase information, using an equation that includes a weighted combination of the differential phase information of the respective directions with the weights of the respective directions set by the weight setting unit.

The present invention in its second aspect provides an imaging system, including: an imaging apparatus that forms an image by forming an interference pattern by interfering with electromagnetic waves that have passed through an object and detecting that interference pattern with a detector; and the phase information acquisition apparatus according to the present invention, which acquires differential phase information on the object from image data obtained by the imaging apparatus, and acquires phase information from the differential phase information.

The present invention in its third aspect provides a phase information acquisition method for acquiring phase information from differential phase information on an object by a computer, the method including: acquiring differential phase information with respect to a plurality of directions; individually setting weights for the differential phase information of the respective directions; and determining phase information, using an equation that includes a weighted combination of the differential phase information of the respective directions with the weights of the respective directions.

The present invention in its fourth aspect provides a non-transitory computer-readable storage medium, which stores a program for causing a computer to execute each step of the phase information acquisition method according to the present invention.

When acquiring phase information from differential phase information, phase information can be accurately determined by inhibiting the effects of abnormal values included in the differential phase information.

Further features of the present invention will become apparent from the following description of exemplary embodiments with reference to the attached drawings.

### BRIEF DESCRIPTION OF THE DRAWINGS

FIG. 1 is a schematic diagram of an imaging system according to an embodiment;

FIGS. 2A to 2C are examples of objects and differential phase images used in an example;

FIG. 3 is an example of a phase image obtained from the differential phase images of FIGS. 2B and 2C using a method of the prior art;

FIG. 4 is a block diagram of functions involved in phase information acquisition processing;

FIGS. 5A to 5C are examples of weighting and phase images in Example 1; and

FIGS. 6A to 6C are examples of weighting and phase images in Example 2.

### DESCRIPTION OF THE EMBODIMENTS

The present invention relates to a technique for acquiring phase information from differential phase information, and is particularly preferable in processing for retrieving a phase image from a differential phase image obtained with a differential interferometer. In addition, although the following embodiments describe examples in which the present invention is applied to a Talbot-type X-ray phase imaging apparatus, the present invention can also be applied to all types of apparatuses of a type that observe phase changes in electromagnetic waves and acquire differential phase information therefrom. Light, X-rays or an electron beam can be used as electromagnetic waves.

Conventional integral methods consist of using two differential phase images in the x direction and y direction to determine a single integrated phase image. In other words, in the case of the unknown N number of phase information items, twice that number (2N) of differential phase information is used for calculations. This results in an overdetermined system for the equation. For this reason, if abnormal values attributable to noise and the like are included in differential phase information in the x direction or y direction, there is the risk of the effects of those abnormal values spreading over a wide range. In other words, conventional integral methods have the problem of the effects of abnormal values appearing as distortion (artifact) of the integrated phase not only at the applicable point but also extending to the periphery thereof.

With the foregoing in view, an object of the present invention is to provide a technology for accurately determining phase information by inhibiting the effects of abnormal values included in differential phase information when acquiring phase information from differential phase information.

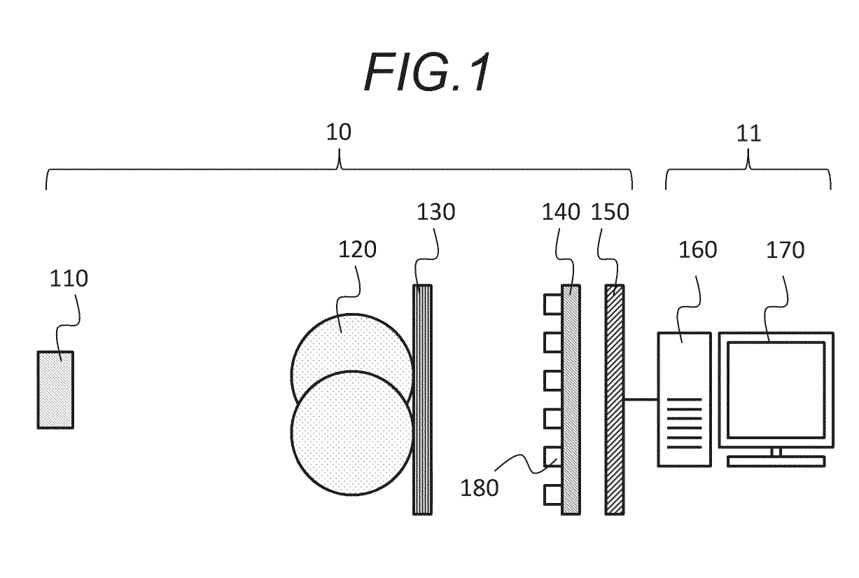

The following provides an explanation of embodiments of the present invention. FIG. 1 is a drawing showing the configuration of an imaging system of Talbot X-ray phase imaging. The imaging system is formed of an imaging apparatus 10 formed of an X-ray Talbot interferometer, and an image processing apparatus 11 that processes X-ray images acquired with the imaging apparatus 10. The imaging apparatus 10 is provided with an X-ray source (light source) 110 that generates X-rays, a diffraction grating 130 that diffracts X-rays, a shield grating 140 that shields a portion of the X-rays, and a detector 150 that detects X-rays. The image processing apparatus 11 has a computing unit (computer) 160 connected to the imaging apparatus 10, and an image display device 170 that displays images based on the results of processing by the computing unit 160.

The computing unit 160 can be formed with a general-purpose computer provided with hardware resources such as a central processing unit (CPU), random access memory (RAM) and auxiliary storage device. Image processing, various calculations and control to be subsequently described are realized by loading a program stored in the auxiliary storage device and executing the program with the CPU. Furthermore, all or a portion of the functions of the computing unit 160 can be formed with a circuit in the manner of an application specific integrated circuit (ASIC).

X-rays from the X-ray source 110 are diffracted by the diffraction grating 130 and form an interference pattern 180 in which bright portions and dark portions are arranged in rows at a prescribed distance referred to as Talbot length.

Normally, the period of the first interference pattern 180 generated by the diffraction grating 130 is several micrometers to about tens of micrometers. Therefore, the shield grating 140, which has a period that is the same as or differs only slightly from the first interference pattern 180, is arranged at the position where the first interference pattern 180 is formed. Whereupon, a moire pattern is formed by the first interference pattern 180 and the shield grating 140, and the period of the interference pattern can be expanded to several tens of micrometers or to infinity. The period of the moire pattern can be suitably determined in consideration of the phase retrieval method used and the pixel size of the detector. In the present embodiment, the period of the moire pattern is preferably two times or more the pixel size and equal to or less than the imaging range of the detector. This moire pattern (pattern having spatial periodicity) is formed into an image by the detector 150, which is a two-dimensional image sensor, to obtain two-dimensional data. The interference pattern observed with the detector 150 is referred to as an interference image or moire image. As a result of using this mechanism, imaging of interference patterns having a period of several micrometers to about ten to twenty micrometers can be performed with the detector 150 having resolution about several tens of micrometers squared. However, in cases in which the spatial resolution of the detector 150 is sufficiently high, the shield grating 140 may be omitted and images of the first interference pattern 180 may be formed directly.

During measurement, an object 120 is placed in front of the diffraction grating 130. Although X-rays pass through the object 120 since they are typically highly transmissive, changes in phase occur corresponding to the elemental composition and density of the substance through which the X-rays have passed at that time. This change in phase has an effect on the arrangement of the first interference pattern 180. Consequently, distortion also occurs in the moire pattern formed by the shield grating 140. This distortion can be acquired in the form of differential phase information by calculating with the computing unit 160.

Here, by using a two-dimensional grating having a bidirectional phase structure for the diffraction grating 130 and the shield grating 140, interference patterns detected with the detector 150 can be made to be those having a two-dimensional structure (or in other words, containing differential information of phase with respect to two directions). Image data of an interference image acquired with the detector 150 is sent to the computing unit 160 and stored. The computing unit 160 carries out an arithmetic operation (phase retrieval) on this image data, enabling it to acquire bidirectional differential phase information. In the present embodiment, the z direction is defined as a direction parallel to the X-ray optical axis, the x direction and the y direction are defined as the horizontal direction and the vertical direction of the detection plane of the detector 150, respectively. In addition, two-dimensional orthogonal gratings are used for the diffraction grating 130 and the shield grating 140, and periodic structures are arranged so as to be parallel in the x direction and y direction, respectively. As a result, differential phase images in the x direction and differential phase images in the y direction can be acquired. Furthermore, the periodic structure of the gratings is not limited to that of the present embodiment. For example, a grating may be used having periodic structures in a plurality of directions (two directions or more), or a non-orthogonal grating (grating having periodic structures in a plurality of directions that are neither parallel nor orthogonal) may also be used.

The previous explanation has provided an overview of a Talbot X-ray phase imaging apparatus. The following provides a detailed explanation of the processing details and effects of the present apparatus using the results of computer simulations.

As possible methods for acquiring differential phase images from data obtained with the detector 150 when using a Talbot interferometer, for example, the phase shift method and the Fourier transform phase retrieval method are known. Either of these methods can be used in the present invention.

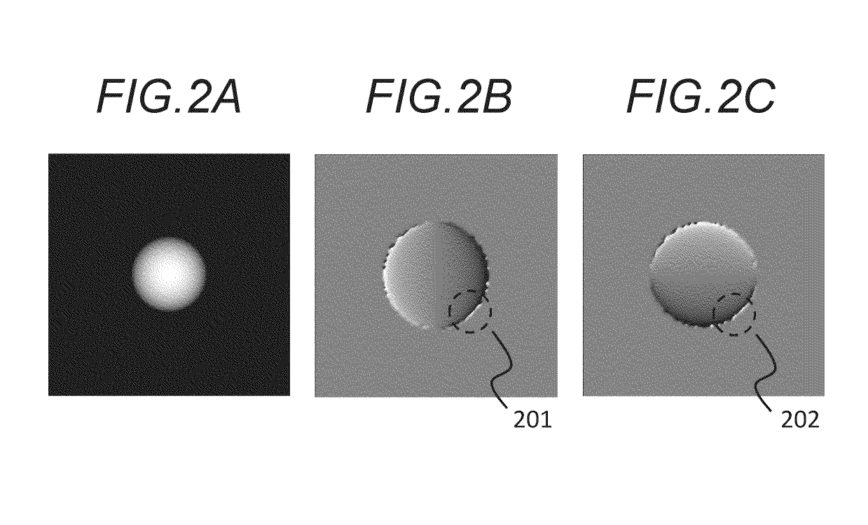

FIGS. 2A to 2C show examples of image data used in a simulation. In the present embodiment, a plastic (Teflon (registered trademark)) sphere having a shape like that shown in FIG. 2A is assumed as the object. FIGS. 2B and 2C respectively show a differential phase image in the x direction and a differential phase image in the y direction acquired by Fourier transform.

As shown in FIGS. 2B and 2C, primary information in the form of differential phase images is obtained with the differential interferometer. Since differential phase images are generally calculated using an argument of a variable, the values thereof wrapped in the 2π period from −π to π. As a result, effects appear such as inversion of differential phase values as indicated by reference symbols 201 and 202 in the drawings at a point such as the edge of an object where differential phase increases. In the images shown in FIGS. 2B and 2C, those portions where white pixels and black pixels are adjacent are portions where inversion of differential phase values is occurring.

Extensive research and development have been conducted on a technique referred to as phase connection (or unwrapping) as a technology for correcting this phase wrapping. However, the majority of this research suggests that there are many cases in which it is difficult to connect phases while being completely free of inconsistency. Consequently, there is increased likelihood of incorrect information (abnormal values) relating to differential phase remaining on the edges.

In addition, factors such as noise and sensor defects have an effect on moire images, and as a result thereof, there are cases in which abnormal values are generated in analyzed differential phases. Although such values are expected to be improved to a certain extent through image filtering and the like, it is difficult to eliminate them completely.

In particular, a problem is presented in the case where a point (pixel) on a differential phase image in the x direction has an abnormal value while there is no abnormality at the same point on a differential phase image in the y direction. In such cases, mathematical inconsistency occurs when determining the phase of those pixels using integration. This mathematical inconsistency also has an effect on pixels other than the abnormal pixel, and causes a considerable decrease in the overall quantitative properties of the phase to be determined as a result thereof.

### COMPARATIVE EXAMPLE

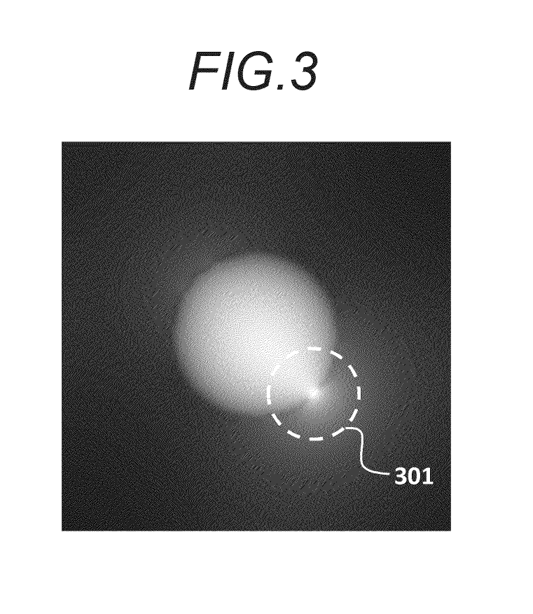

An example in which a phase image has been generated from the differential phase images of FIGS. 2B and 2C is shown as a comparative example in FIG. 3 using the method described in U.S. Pat. No . 9,019,479. Although the method of U.S. Pat. No. 9,019,479 is characterized by being able to reduce noise to a greater degree than the conventionally used Fourier integral method, it does not tolerate abnormal values as described above.

Consequently, when data containing abnormal values as indicated with reference symbol 201 in FIG. 2B and reference symbol 202 in FIG. 2C is processed, the overall deformed shape as indicated by reference symbol 301 in FIG. 3 is output as a result thereof. When compared with the ground truth of FIG. 2A, significant distortion can be seen to occur on the phase image caused by abnormal values on the differential phase image.

### Example 1

The following provides an explanation of Example 1 of the present invention. In Example 1, in order to reduce the influence of abnormal values as indicated in Comparative Example, a weighted integral method is introduced for use as an integration procedure for determining a phase image from a differential phase image. In the case of determining a single integrated phase image using a plurality of differential phase images, there are a plurality of integration paths that can be used to determine each integrated phase value that composes that integrated phase image (each pixel value of the integrated phase image). In the present example, by carrying out weighted integration by increasing the weight of differential phase values having high reliability while decreasing the weight of differential phase values having low reliability, integrated phase values can be determined using a highly reliable integration path. This can be said be a method improving the Poisson's integral method proposed in U.S. Pat. No. 9,019,479. A weighted integral method relating to Poisson's integral is disclosed in U.S. Pat. No. 5,424,743. However, the method of U.S. Pat. No. 5,424,743 solves the problem of phase connection in the form of Poisson's equation, and finds the solution with a weighted least squares algorithm, making it clearly different from an integration procedure for determining a phase image from a differential phase image.

Normally, a Poisson's equation for determining phase as indicated in U.S. Pat. No. 9,019,479 is represented with a discrete format as indicated below.

$$( Φ ( x + 1 , y ) - Φ ( x , y ) ) - ( Φ ( x , y ) - Φ ( x - 1 , y ) ) + ( Φ ( x , y + 1 ) - Φ ( x , y ) ) - ( Φ ( x , y ) - Φ ( x , y - 1 ) ) = {P}_{x} ( x + 1 , y ) - {P}_{x} ( x , y ) + {P}_{y} ( x , y + 1 ) - {P}_{y} ( x , y ) \qquad ( Equation 1 )$$

Here, Φ represents the ase to be determined, Px represents the differential phase in the x direction, Py represents the differential phase in the y direction, and x and y are integers representing he x and y coordinates of the pixel.

This equation is changed using weigting. The weight of the reliability of the differential phase in the x direction is defined as Wx, while the weight of the reliability of the differential phase in the v direction is defined as Wy. The weight is set to be 1 when the differential phase is relable, and to be 0 when the differential phase is not reliable. A value between 0 and 1 may be assigned for the degree of reliabilty. When defined in this manner, the discrete form of Poisson's equation is represented in the manner indicated below.

$$( Φ ( x + 1 , y ) - Φ ( x , y ) ) {W}_{x} ( x + 1 , y ) - ( Φ ( x , y ) - Φ ( x - 1 , y ) ) {W}_{x} ( x , y ) + ( Φ ( x , y + 1 ) - Φ ( x , y ) ) {W}_{y} ( x , y + 1 ) - ( Φ ( x , y ) - Φ ( x , y - 1 ) ) {W}_{y} ( x , y ) = {P}_{x} ( x + 1 , y ) {W}_{x} ( x + 1 , y ) - {P}_{x} ( x , y ) {W}_{x} ( x , y ) + {P}_{y} ( x , y + 1 ) {W}_{y} ( x , y + 1 ) - {P}_{y} ( x , y ) {W}_{y} ( x , y ) \qquad ( Equation 2 )$$

The left side of Equation 2 is a weighted combination of a phase difference between a pixel of interest (x, y) and adjacent pixels (x+1, v) and (x−1, y) in the x direction, and a phase difference between the pixel of interest (x, y) and adjacent pixels (x, y+1) and (x,y−1) in the y direction. In addition, the right side of Equation 2 is a weighted combination of a differential phase value between the pixel of interest (x, y) and the adjacent pixels (x+1, y) and (x−1, y) in the x direction, and a differential phase value between the pixel of interest (x, y) and the adjacent pixels (x,y+1) and (x,y−1) in the y direction.

The weighted discrete Poisson's equation of Equation 2 is generalized with a system of linear equations in matrix form as indicated below:

WAx=Wb.

Here, A represents a coefficient matrix, x represents a phase vector (also referred to as a variable vector) that is unknown, b represents a differential phase vector, and W represents a weight matrix.

Since the number of equations is greater than the number of unknowns, this problem can be solved by using a method for solving least squares problem such as the conjugate gradient method (CG method) or the preconditioned conjugate gradient method (PCG method). Since a method for generating a matrix and a method for deriving a solution using the conjugate gradient method and the like are known (see, for example, U.S. Pat. No. 5,424,743), explanations thereof are omitted here.

Integration values are compensated for by carrying out weighting individually in the x direction and y direction. In Example 1, amplitude of the interference image (moire pattern) in the x direction is used for the weight Wx in the x direction, while amplitude of the interference image (moire pattern) in the y direction is used for the weight Wy in the y direction. As the amplitude of an interference image becomes smaller, reliability of differential phase information included in the interference image decreases due to the effects of noise and the like. Since pixels for which the reliability of differential phase information is low are thought to have a high possibility of having abnormal values, the effects of abnormal values can be reduced by using the amplitude thereof as weight. In the present example, values obtained by respectively normalizing amplitude in the x direction and amplitude in the y direction acquired from an interference image are used as weight Wx in the x direction and weight Wy in the y direction. Furthermore, not only values obtained by normalizing amplitude, but also values having a positive correlation with amplitude (to be referred to as amplitude information) can also be used as weight. For example, the visibility value of an interference image is one of the amplitude information. The distribution of visibility values can be acquired by, for example, carrying out Fourier transform on the interference image, extracting a portion at the carrier frequency and periphery thereof, moving it to the origin, carrying out inverse Fourier transform, and calculating the absolute value thereof.

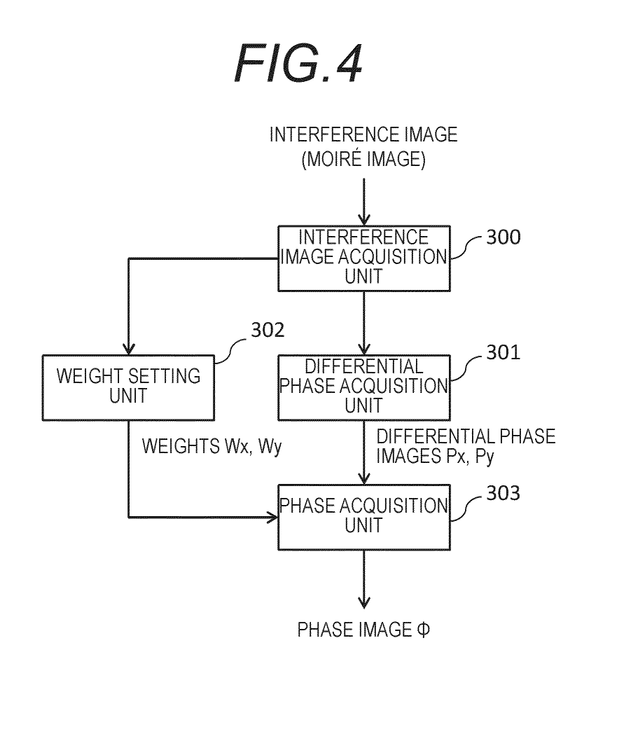

FIG. 4 is a block diagram of functions involved in phase information acquisition processing in the image processing apparatus 11. These functions are realized with an interference image acquisition unit 300, a differential phase acquisition unit 301, a weight setting unit 302 and a phase acquisition unit 303. The interference image acquisition unit 300 provides the function of acquiring data of an interference image (moire image) from the imaging apparatus 10. The differential phase acquisition unit 301 provides the function of respectively generating differential phase images in the x direction and y direction from the interference image in accordance with a prescribed phase retrieval method. Any method may be used for the phase retrieval method. The weight setting unit 302 provides the function of individually setting the weights for the differential phases of the respective directions based on the amplitudes of the interference image acquired by the interference image acquisition unit 300. The phase acquisition unit 303 provides the function of establishing a weighted Poisson's equation using the differential phase Px in the x direction, the differential phase Py in the y direction, the weight Wx in the x direction and the weight Wy in the y direction of each pixel, and determining the phase value q of each pixel by a solution method such as the conjugate gradient method.

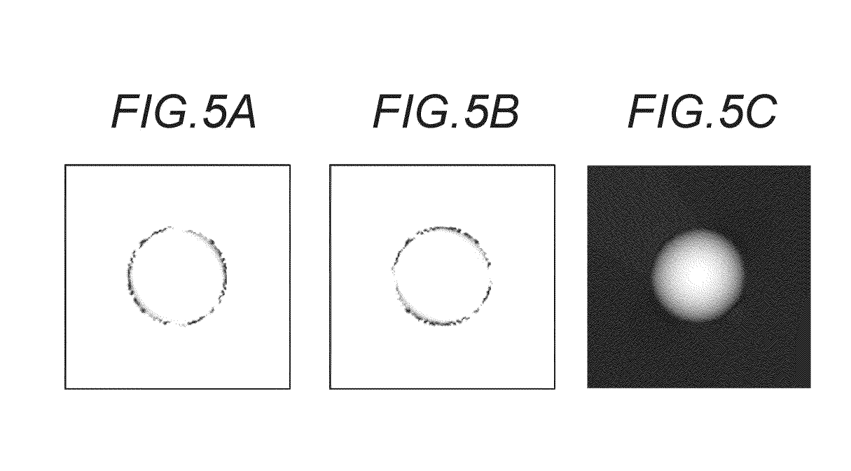

Graphical representations of the values of the weight Wx in the x direction and the weight Wy in the y direction are respectively shown in FIG. 5A and FIG. 5B. Weights range from values of 0 to 1, a weight of 0 is indicated with a black pixel, a weight of 1 is indicated with a white pixel, and a value between 0 and 1 is indicated with a gray pixel. Weight can be seen to decrease on the edge of the object. In addition, it can be understood that pixels having small weights (pixels having low reliability) in the x direction are different from that in the y direction.

As a result of using this weighted integral method, when determining the phase of each point (each pixel) on an image, among differential phase information of each of the x and y directions having a point of interest (pixel of interest) in the center, phase values are determined by preferentially using information having higher reliability. Namely, phase information is determined for a pixel for which the reliability of differential phase information in the x direction is low by only using differential phase information in the y direction or by mainly using differential phase information in the y direction. Conversely, phase information is determined for a pixel for which the reliability of differential phase information in the y direction is low by only using differential phase information in the x direction or mainly using differential phase information in the x direction. In addition, phase information is determined for pixels for which reliability is high in both the x and y directions from differential phase information in both the x and y directions.

In other words, in the case of using a simple integral method, Φ(x, y) was determined by adding Px(x,y) to Φ(x−1, y) and adding Py (x, y) to Φ(x, y−1) . On the other hand, in the present example, that information among Px(x,y), Px (x+1, y) , Py (x, y) and Py (x, y+1) having the highest reliability is preferentially used and Φ(x, y) is determined from at least any of Φ(x−1, y), Φ(x+1, y), Φ(x, y−1) and Φ(x, y+1) . In this manner, in the present example, Φ(x, y) can be determined by going through the integration path having higher reliability. For example, if weighting is implemented on an interference image per se and the weighted interference image is integrated, an integration value (phase value) in a region where the weight is 0 cannot be acquired. However, if weighting is respectively carried out in the x and y directions as in the present example, integration values can be determined by finding an integration pathway having high reliability.

According to the above method, highly accurate phase information can be acquired. FIG. 5C indicates a phase image acquired according to the weighted integration of Example 1. Distortion can be understood to have qualitatively decreased in comparison with the comparative example (FIG. 3).

### Example 2

As was previously described, abnormal values that cause phase wrapping have a high likelihood of appearing on the edge of an object. Therefore, in Example 2, edges are respectively detected (extracted) in the x direction and y direction using differential phase images in the x direction and y direction, and the weight having the negative correlation with edge intensity (edge likelihood) is used. More specifically, an absolute value of a value obtained by further differentiating the differential phase in the x direction with respect to the x direction (secondary differential value of phase with respect to the x direction) is calculated, and a value obtained by subtracting the normalized absolute value from 1 is used as the weight Wx in the x direction. Similarly, an absolute value of the secondary differential value of phase with respect to the y direction is calculated, and a value obtained by subtracting the normalized absolute value from 1 is used as the weight Wy in the y direction. Weights Wx and Wy acquired in this manner are effective for use as parameters that identify a location such as the edge of an object where the reliability of differential phase information is low. Furthermore, functions involved in phase information acquisition processing of Example 2 are the same as in Example 1 (FIG. 4) , and are composed of the interference image acquisition unit 300, the differential phase acquisition unit 301, the weight setting unit 302 and the phase acquisition unit 303. However, the weight setting unit 302 differs only in that weights are set based on differential phase values obtained with the differential phase acquisition unit 301.

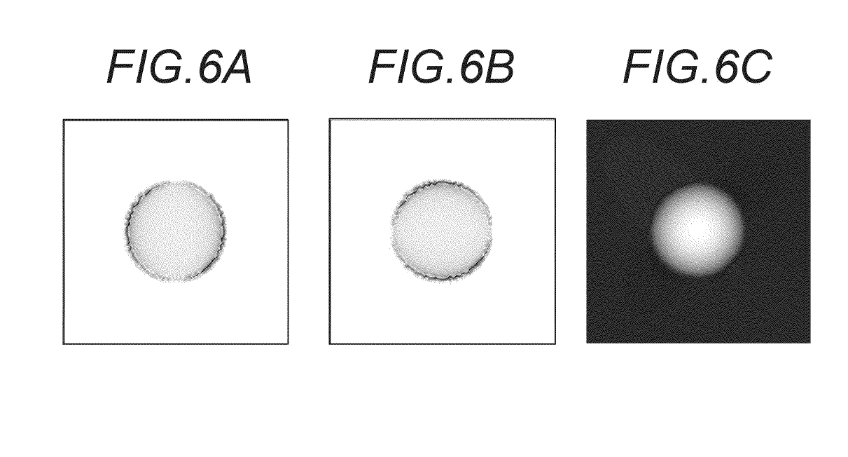

Graphical representations of the values of the weights Wx and Wy of Example 2 are respectively shown in FIG. 6A and FIG. 6B. Weights range from values of 0 to 1, a weight of 0 is indicated with a black pixel, a weight of 1 is indicated with a white pixel, and a value between 0 and 1 is indicated with a gray pixel. Weight can be seen to decrease on the edge of the object. In addition, it can be understood that pixels having small weights (pixels having low reliability) in the x direction are different from that in the y direction. FIG. 6C indicates a phase image acquired according to the weighted integration of Example 2. Distortion can be understood to have decreased in comparison with the comparative example in the same manner as in the case of Example 1.

Table 1 represents the degree to which quantitative properties are improved by using the integral method of Examples 1 and 2. The values in Table 1 were obtained by averaging, in the whole image, the mean square of the difference between the true phase value of a virtual phantom used in the simulation and each phase value obtained in the comparative example (FIG. 3), Example 1 (FIG. 5C) and Example 2 (FIG. 6C). In other words, the smaller the value, the greater the degree to which distortion is reduced. According to Table 1, the degree of improvement is clearly greater in Examples 1 and 2 than in the comparative example, thereby demonstrating the efficacy of the weighted integral method according to the present invention.

TABLE 1

| | Residual Mean |
|---|---|
| Comparative | 7.310 |
| Example | |
| Example 1 | 4.363 |
| Example 2 | 4.368 |

### Other Examples

The previously described examples are merely intended to indicate specific examples of the present invention, and the scope of the present invention is not intended to be limited to these specific examples.

For example, various other forms can be considered for the weight determination method in addition to that used in Examples 1 and 2. For example, the edge of an object can be detected using the differential image or secondary differential image of an X-ray absorption image, and weight having a negative correlation with edge intensity can be set in the same manner as Example 2. In addition, in the case a detector defect (such as a pixel defect) is known in advance, the weight of the pixel corresponding to that defect may be decreased. In addition, an interference image or differential phase image may be displayed on a display device, a location of low reliability may be designated and selected by a user, and the weight of that location maybe decreased. Other weight determination methods may also be used. Namely, when retrieving phase information based on differential phase information in two or more directions, weight is set corresponding to reliability with respect to the differential phase information of each direction.

In addition, although the above-mentioned examples indicated the example of an X-ray Talbot interferometer using a two-dimensional grating, the application range of the present invention is not limited thereto. The present invention can also be preferably applied to an apparatus by which differential phase information is obtained in at least two directions (two dimensions). In addition, the present invention can also be applied to interferometers using electromagnetic waves of various wavelengths and types other than X-rays (such as an optical interferometer). In addition, the present invention can be applied to an instrument other than an interferometer provided it is able to obtain differential phase information of an object. In addition, the imaging apparatus to which the present invention is applied may have a configuration that is separated from the X-ray source or electromagnetic wave source and performs imaging in combination with the X-ray source or electromagnetic wave source. Furthermore, in the present invention and present description, an imaging apparatus refers to any apparatus that captures images of a periodic pattern, and is not limited to that which forms images from object information.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to readout and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-121396, filed on Jun. 12, 2014, which is hereby incorporated by reference herein in its entirety.

What is claimed is:

1. A phase information acquisition apparatus that acquires phase information from differential phase information on an object, comprising:
a differential phase acquisition unit that acquires differential phase information with respect to a plurality of directions;
a weight setting unit that individually sets weights for the differential phase information of the respective directions; and
a phase acquisition unit that determines phase information, using an equation that includes a weighted combination of the differential phase information of the respective directions with the weights of the respective directions set by the weight setting unit.

2. The phase information acquisition apparatus according to claim 1, further comprising
an interference image acquisition unit that acquires interference image data on an object obtained by a differential interferometer, wherein
the differential phase acquisition unit determines differential phase information on each direction from the interference image data.

3. The phase information acquisition apparatus according to claim 2, wherein
the differential interferometer is a Talbot interferometer.

4. The phase information acquisition apparatus according to claim 2, wherein
the weight setting unit sets a weight for a second differential phase information larger than a weight fora first differential phase information, the second differential phase information having higher reliability than the first differential phase.

5. The phase information acquisition apparatus according to claim 2, wherein
the weight setting unit sets the weight of each direction, based on a value of amplitude of the interference image in each direction.

6. The phase information acquisition apparatus according to claim 2, wherein
the weight setting unit detects an edge of the object in each direction, using an image of the object acquired from the interference image, and sets the weight of each direction, based on an intensity of the detected edge.

7. The phase information acquisition apparatus according to claim 6, wherein
the image of the object acquired from the interference image is a differential phase image or an absorption image of the object.

8. The phase information acquisition apparatus according to claim 1, wherein
the phase acquisition unit acquires phase information by finding a solution of a system of linear equations that includes the weighted combination of the differential phase information of the respective directions with the weights of the respective directions, and a term of phase information that is unknown.

9. The phase information acquisition apparatus according to claim 8, wherein
the phase acquisition unit finds the solution of the system of linear equations, using a method for solving least squares problem.

10. An imaging system, comprising:
an imaging apparatus that forms an image by forming an interference pattern by interfering with electromagnetic waves that have passed through an object and detecting that interference pattern with a detector; and
the phase information acquisition apparatus according to claim 1, which acquires differential phase information on the object from image data obtained by the imaging apparatus, and acquires phase information from the differential phase information.

11. A phase information acquisition method for acquiring phase information from differential phase information on an object by a computer, the method comprising:
acquiring differential phase information with respect to a plurality of directions;
individually setting weights for the differential phase information of the respective directions; and
determining phase information, using an equation that includes a weighted combination of the differential phase information of the respective directions with the weights of the respective directions.

12. A non-transitory computer-readable storage medium, which stores a program for causing a computer to execute each step of the phase information acquisition method according to claim 11.
